(19) United States
(12) Patent Application Publication
(10) Pub. No.: US 2024/0232314 A1
(43) Pub. Date: Jul. 11, 2024

(54) AUTHENTICATOR TO AUTHORIZE PERSISTENT OPERATIONS

(71) Applicant: DELL PRODUCTS L.P., Round Rock, TX (US)

(72) Inventors: Bradley Keith Goodman, Nashua, NH (US); Stav Sapir, Burlington, MA (US)

(21) Appl. No.: 18/153,029

(22) Filed: Jan. 11, 2023

(51) Int. Cl. G06F 21/33

(52) U.S. Cl. CPC G06F 21/33

(57) ABSTRACT

A control plane node of a multiple node environment includes a storage and a processor. The storage stores a signed authorization certificate. The signed authorization certificate grants permission to a user to perform an operation within an endpoint of the multiple node environment. The processor receives, from a client node, a request including a work order for the operation to be performed in the endpoint node. In response to reception of the request, the processor provides a request certificate to an authenticator device associated with an administrator of the endpoint node, and receives a signed request certificate. The processor provides the signed request certificate to the endpoint node for verification.

### FIELD OF THE DISCLOSURE

The present disclosure generally relates to information handling systems, and more particularly relates to authenticating persistent operations using an authenticator.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

A control plane node of a multiple node environment includes a storage and a processor. The storage may store a signed authorization certificate. The signed authorization certificate may grant permission to a user to perform an operation within an endpoint of the multiple node environment. The processor may receive, from a client node, a request including a work order for the operation to be performed in the endpoint node. In response to reception of the request, the processor may provide a request certificate to an authenticator device associated with an administrator of the endpoint node, and receive a signed request certificate. The processor may provide the signed request certificate to the endpoint node for verification.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a multiple node environment according to at least one embodiment of the present disclosure;

FIG. 2 is a flow diagram of a method for creating a public and private key pair according to at least one embodiment of the present disclosure;

FIG. 3 is a flow diagram of a method for enabling a user login via an authenticator device according to at least one embodiment of the present disclosure;

FIG. 4 is a flow diagram of a method for authenticating work order requests via an authenticator device according to at least one embodiment of the present disclosure;

FIG. 5 is a flow diagram of a method for generating a long lived attestation according to at least one embodiment of the present disclosure;

FIG. 6 is a flow diagram of a method for utilizing a long lived attestation to authenticate a work order request according to at least one embodiment of the present disclosure; and

FIG. 7 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

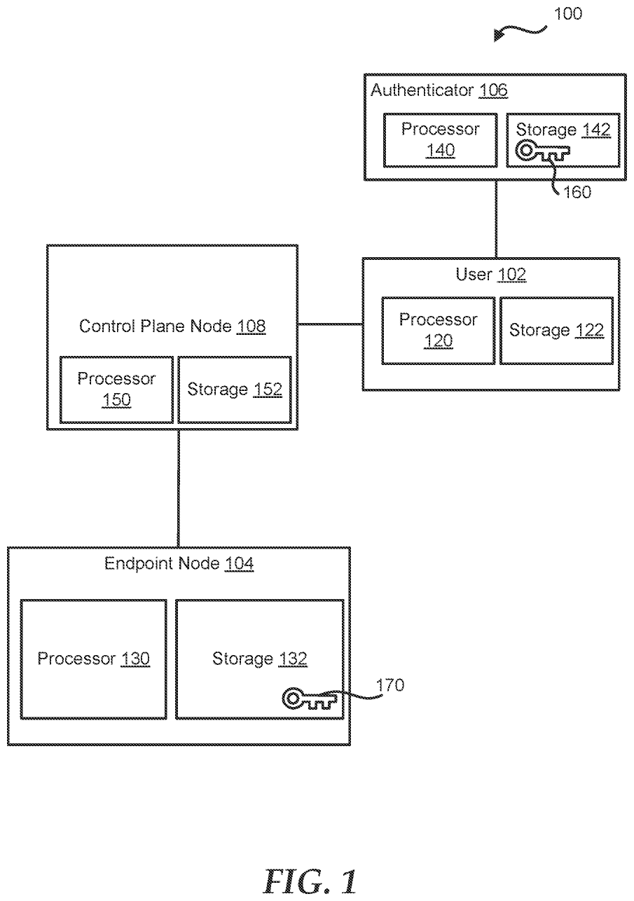

FIG. 1 illustrates a multiple node environment 100 according to at least one embodiment of the present disclosure. Multiple node environment 100 includes a user node 102, an endpoint node 104, an authenticator node 106, and a control plane node 108. In an example, user node 102 and authenticator node 106 may communicate with endpoint node 104 through control plane 108. In certain examples, each user node 102 includes a processor 120 and a memory. Endpoint node 104 includes a processor 130 and a storage 132. Authenticator node 106 includes a processor 140 and a storage 142. Control plane node 108 includes a processor 150 and a storage 152.

In an example, endpoint node 104 may execute one or more services that a user may sign into via for user node 102. These services may include, but are not limited to, a web site and a remote system. In certain examples, authenticator 106 may be any suitable component or hardware device in possession of a user associated with user node 102. Authenticator 106 may hold or store a private key 160 associated with the user. In an example, authenticator 106 may be a platform component, such as a component within a laptop, a roaming authenticator, such as a key fob which can be used on different devices, or the like.

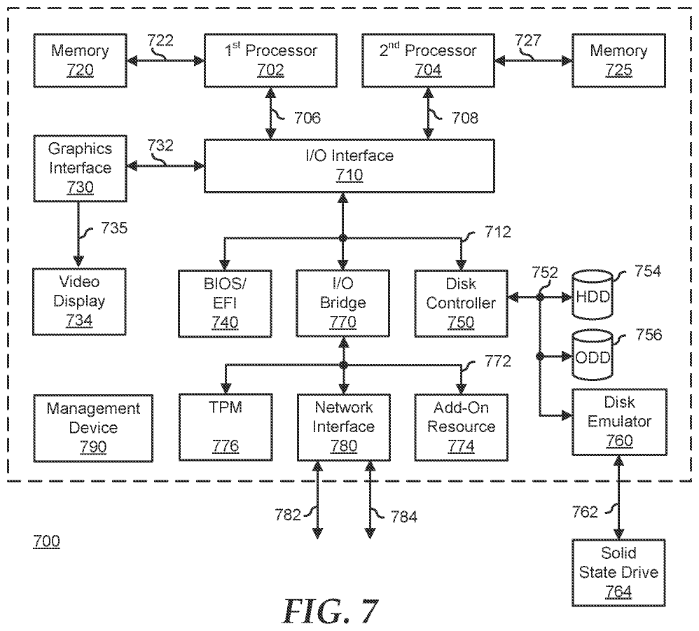

In certain examples, control plane 108 may include any suitable type of control-plane, such as a global control plane node, regional control plane node, and local control plane node. In an example, user node 102, endpoint node 104, and authenticator 106, and control plane node 108 may be any suitable information handling system, such as substantially similar to information handling system 700 of FIG. 7, wherein each node may include a storage and a processor as described below with respect to FIG. 7. Multiple node environment 100 may include any suitable number of additional components or information handling systems without varying from the scope of this disclosure.

In certain examples, user node 102 may generate a request including, but not limited to, an imperative request and a declarative request. In an example, the request may enable user node 102 to access endpoint node 104 and cause one or more operations to be performed in the endpoint node. In certain examples, an imperative request or command may involve a particular action to be performed. For example, an imperative request may be for a memory in an endpoint, such as storage 132 in endpoint 104, to be locked. In response to the imperative request being validated, endpoint 104 may lock storage 132. Subsequently, another request may be received to unlock storage 132 at which point the storage may be unlocked and the imperative request may no longer have any effect.

In an example, a declarative/persistent request or command may involve an action to be performed for an extended amount of time. For example, a declarative request may indicate that storage 132 should be locked. In response to the declarative/persistent request, processor 130 of endpoint node 104 may lock the designated storage. Subsequently, another request may be received to unlock storage 132 at which point processor 130 may unlock the storage. In an example, the declarative/persistent request may be different than an imperative request based on the declarative request still being implemented after a subsequent request was performed. For example, if the declarative request is for storage 132 to be locked and a subsequent request unlocks the memory, the declarative request may cause the storage to be locked again after the subsequent request is no longer being performed. In certain examples, a component, such as storage 132, in endpoint node 104 may have a default state, and a declarative request may cause the endpoint to place the component in a declarative state. In an example, an invalidate request may end the declarative request or state so that the component is placed back in the default state.

In certain examples, authenticator 106 may perform one or more operations to authenticate or validate a request provide by user node 102 to endpoint node 104. In an example, authenticator 106 may implement WebAuthn (FIDO2) Authentication, which is an end-to-end open industry standard. WebAuthn authentication may utilize public/private key asymmetric digital signatures to authenticate a user, such as user node 102, to a web site or online service executed within endpoint node 104. In particular, WebAuthn may describe a protocol by which a user may utilize an authenticator, such as authenticator 106. In an example, the WebAuthn may enroll or store a public key 170 within storage 132 of endpoint node 104. Public key 170 may be associated with a private key 160 within storage 142 of authenticator 106. In an example, user node 102 may utilize the public/private key combination during a web site registration time. After the storage of public key 150, endpoint node 104 may send a cryptographic challenge to authenticator 106. When authenticator 106 signs and returns that challenge with registered private key 152, the web server may be able to verify that the challenge was signed by the enrolled key, and therefore the user is allowed to log in.

In an example, endpoint node 104 may be improved by endpoint node 104 providing a durable long-lived permission or work request signed by authenticator 106 via WebAuthn or any other suitable public/private key authentication process. In this example, a work request or any type of request from user node 102 to endpoint node 104 may be signed by authenticator 106 and the signed request may be provided to endpoint node 104 via control plane 108. In an example, endpoint node 104 may require a cryptographically signed certificate to validate the operation of the received request. The cryptographically signed certificates may be received from different users, places, and generated at different times. The signed certificates may have even been generated by different authentication operations other than WebAuthn.

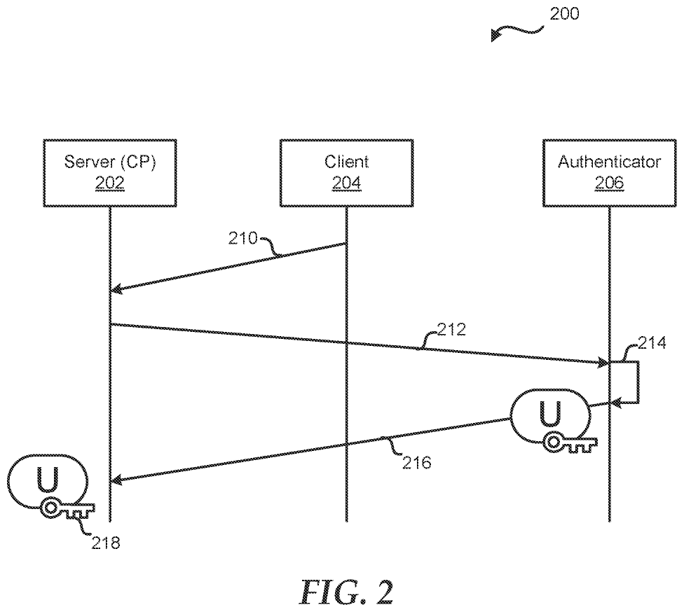

In certain examples, certificates to authenticate a user request may be received or signed by authenticator 106 previously, such as a request generated long before a current request be assessed within endpoint node 104. For example, the previous user request may have been signed by authenticator 106 via a payload of a challenge provided from endpoint node 104 to authenticator 106. In an example, the validation of the signed certificate from authenticator 106 may be assessed by a component other than endpoint node 104 that generated the challenge based on the challenge being a payload of a message. Different validation processes will be described with respect to FIGS. 2-6 below.

FIG. 2 illustrates a flow diagram of a method 200 for creating a public and private key pair via a server 202 a client node 204 and an authenticator 206 according to at least one embodiment of the present disclosure. Server 202 may be substantially similar to control plane 108 of FIG. 1, client node 204 may be substantially similar user node 102 of FIG. 1, and authenticator 206 may be substantially similar to authenticator 106 of FIG. 1.

At operation 210, client node 204 may provide a registration request to server node 202. In response to the registration request, server node 202 may provide authenticator 206 with a request to register a new public/private key combination at operation 212. At operation 214, authenticator 206 creates a new public/private key pair or combination. In an example, authenticator 206 may store the new private key in a storage of the authenticator, such as storage 142 of authenticator 106 in FIG. 1. At operation 216, authenticator 206 provides the public key of the key pair to server node 202. At operation 218, server node 202 stores the new public key in a storage. In an example, the new public key is associated with the user of client node 204.

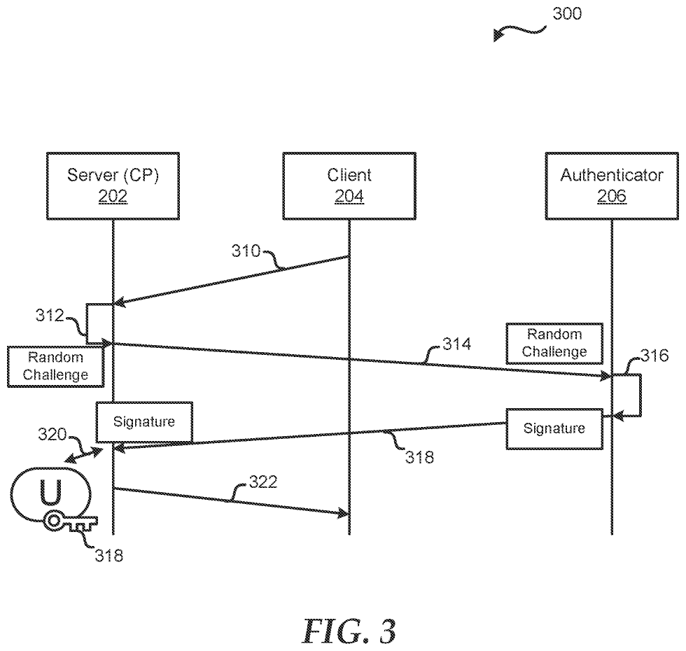

FIG. 3 is a flow diagram of a method 300 for enabling a user login via an authenticator device according to at least one embodiment of the present disclosure. In certain examples, the user login may be completed by any suitable components including, but not limited to, server node 202, client node 204, and authenticator 206. In an example, client node 204 may be any suitable device, such as an information handling system 700 of FIG. 7. Server/control plane 202 may be substantially similar to control plane node 108 of FIG. 1, client node 204 may be substantially similar to user node 102 of FIG. 1, and authenticator 206 may be substantially similar to authenticator 106 of FIG. 1.

At operation 310, client node 204 may provide a user login request to server 202. In response to the user login request, server 202 may generate a random challenge at operation 312. In an example, the random challenge may be a cryptographic challenge, such that the random challenge is original to server 202. At operation 314, server 204 may provide the random challenge to authenticator 206. In an example, the random challenge may be provided to authenticator 206 via any suitable manner or communication path. For example, server 202 may provide the random challenge to authenticator 206 via a communication path through client node 204. In an example, the communication path for the random challenge may go through client node 204 for any suitable reason including, but not limited to, authenticator 206 being a key fob connected to client node 204.

At operation 316, authenticator 206 may sign with random challenge with a private key. At operation 318, authenticator 206 provides the signed random challenge to server 202. At operation 320, server 202 verifies that the challenge was signed by the correct private key. In an example, the correct private key may be the private key associated with a public key for the user of client node 204 and stored in a storage of server 202. In an example, the public/private key combination is utilized by server 202 to verify that the challenge has been properly signed by a holder of the private version of the key combination. At operation 322, an access grant is provided to client node 204 and the user is able to access server 202 via the client node.

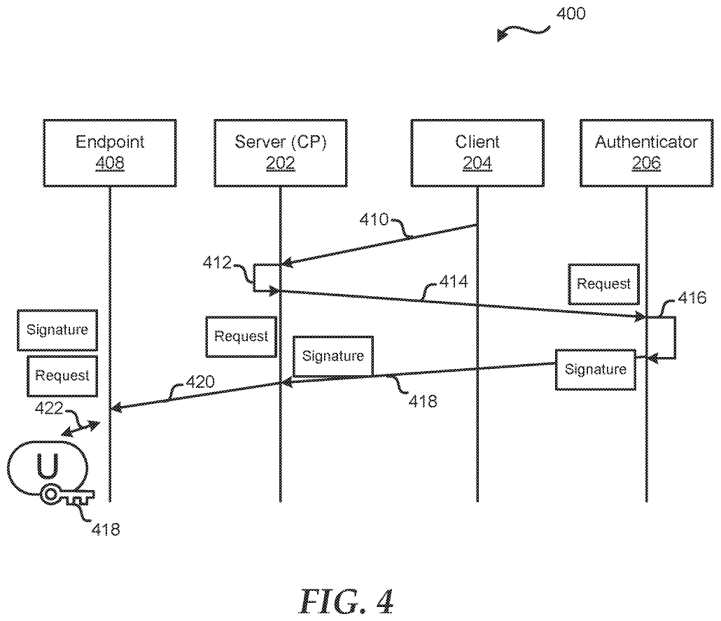

FIG. 4 is a flow diagram of a method 400 for authenticating work order requests via an authenticator according to at least one embodiment of the present disclosure. In certain examples, the work order and authentication may be completed by any suitable components including, but not limited to, server node 202, client node 204, authenticator 206, and an endpoint 408. In an example, server/control plane 202 may be substantially similar to control plane node 108 of FIG. 1, client node 204 may be substantially similar to user node 102 of FIG. 1, authenticator 206 may be substantially similar to authenticator 106 of FIG. 1, and endpoint node 408 may be substantially similar to endpoint node 104 of FIG. 1.

At operation 410, client node 204 provides a work order request to server 202. In certain examples, the work order request may be a declarative/persistent request, an imperative request, or the like. In an example, server 202 may be a control plane that provides access to one or more endpoints 408. In this situation, endpoint 408 may identify server/control plane 202 may be a trustworthy device, such that endpoint 408 may perform or execute any commands received from server 202. In an example, a user may utilize client node 204 to log into server 202 via any suitable manner, such as the operations described above with respect to FIG. 3, the WebAuthn operations, or the like.

At operation 412, server 202 may create/replicate a request associated with the work order from client node 204. At operation 414, server 202 may provide the request to authenticator device 206. The request may be any suitable request such as a request certificate. As used herein, a request certificate may be a long-lived certificate that provides authority for a declarative/persistent work order from client node 204 to be executed in endpoint 408. In an example, server 202 may provide the request to authenticator device 206 via any suitable manner or communication path. For example, server 202 may provide the request to authenticator device 206 via a communication path through client node 204. In an example, the communication path for the random challenge may go through client node 204 for any suitable reason including, but not limited to, authenticator 206 being a key fob connected to client node 204.

At operation 416, authenticator node/device 206 may sign the request with a private key associated with the user of client node 204. At operation 418, authenticator 206 may provide the signed request to server 202. In an example, authenticator 206 may provide the sign request to server 202 via the same communication path that the server sent the request to the authenticator. In certain examples, authenticator 206 may sign and return the request certificate via any suitable protocol such as WebAuthn or the like.

At operation 420, server 202 may provide the signed request certificate to one or more endpoints 408. At operation 422, endpoint 408 may verify that the request certificate was signed by the correct private key. In an example, the correct private key may be the private key associated with a public key for the user of client node 204 and stored in a storage of server 408. In an example, the public/private key combination is utilized by endpoint 408 to verify that the challenge has been properly signed by a holder of the private version of the key combination. During an enrollment/onboard process for endpoint 408, an identification of an administrator for the endpoint may be stored in a storage of the endpoint. The administrator may be identified in any suitable manner, such as by the associated public key being stored in endpoint 408. In certain examples, endpoint 408 may receive the public key by any suitable manner including, but not limited to, reception from server 202, via a separate process which may even share this public key with the server/control plane. In response to the signature being verified for the request certificate, the operation of the work order may be performed within endpoint 408.

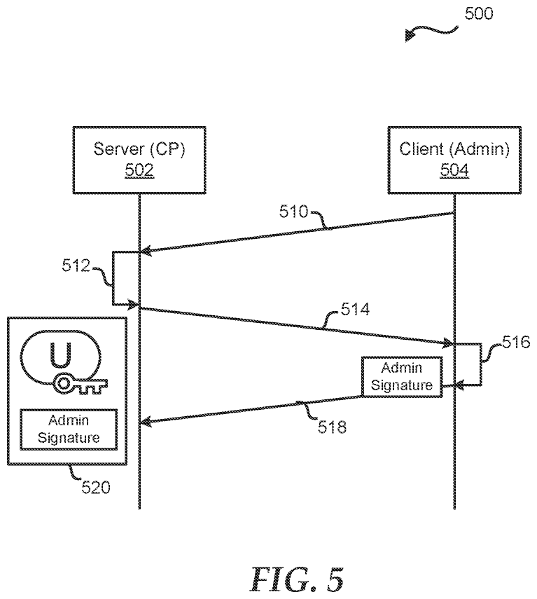

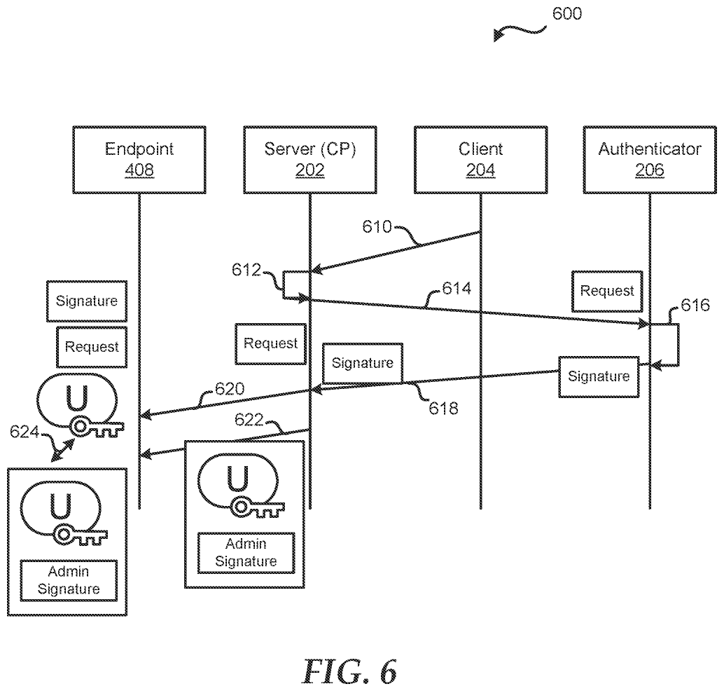

In an example, client node 204 may provide a work order within a certificate, such as Web SSL certificates, in which endpoint node 408 may having no direct knowledge of server certificates. In this example, endpoint node 408 may have knowledge of root certificate authorities, which may utilize intermediate certificate authorities to attest trust downward to the endpoint. In certain examples, any conveyance of permissions may be done via WebAuthn-signed requests as described above with respect to FIG. 4. For example, endpoint 408 may not know the user associated with client node 204 but knows authenticator 206, which in turn may or may not be associated with the client node. In this example, an individual with authenticator 206 may utilize the authenticator sign a request to grant permission to the user of client node 204 as will be described with respect to FIGS. 5 and 6 below.

FIG. 5 is a flow diagram of a method 500 for generating a long-lived attestation according to at least one embodiment of the present disclosure. The operations of method 500 may be performed by any suitable number of information handling systems, such as a server/control plane node 502 and a client/administrator node 504. In an example, server/control plane 502 may be substantially similar to control plane node 108 of FIG. 1.

At operation 510, an administrator may utilize client/administrator node 504 to provide an authorization certificate to server/control plane 502. In an example, the authorization certificate may grant permission to a user to request one or more operations to be performed at an endpoint. At operation 512, server node 502 may generate a request message. In an example, the message may include the authorization certificate as a payload of the message. At operation 514, server node 502 may provide the request message to client node 504, which in turn may sign the request message at operation 516. In an example, client node 504 may sign the request message with a private key for an administrator of an endpoint node.

At operation 518, client node 504 may provide the signed request message to server 502. At operation 520, server 502 may store the authorization certificate and signature generated from the private key of the administrator in a storage of the server node 502. In an example, the authorization certificate may not be an imperative, ephemeral, or one-time operation but may be a long-lived authorization request. In certain examples, any entity with the public key of the administrator may, at any time, verify that the administrator has signed the message that includes the authorization certificate and the signature. In this situation, WebAuthn may be used to sign a message and also used as a way of continuously attesting a long-standing rule or permission.

FIG. 6 is a flow diagram of a method 600 for utilizing a long-lived attestation to authenticate a work order request according to at least one embodiment of the present disclosure. In certain examples, the work order and authentication may be completed by any suitable components including, but not limited to, server node 202, client node 204, authenticator 206, and an endpoint 408. In an example, server/control plane 202 may be substantially similar to control plane node 108 of FIG. 1, client node 204 may be substantially similar to user node 102 of FIG. 1, authenticator 206 may be substantially similar to authenticator 106 of FIG. 1, and endpoint node 408 may be substantially similar to endpoint node 104 of FIG. 1.

At operation 610, client node 204 provides a work order request for endpoint node 408 to server 202. In certain examples, the work order request may be a declarative/persistent request, an imperative request, or the like. In an example, server 202 may be a control plane that provides access to one or more endpoints 408. In an example, a user may utilize client node 204 to provide a declarative request to endpoint node 408.

At operation 612, server 202 may create/replicate a request associated with the work order from client node 204. At operation 614, server 202 may provide the request to authenticator device 206. The request may be any suitable request such as a request certificate. As used herein, a request certificate may be a long-lived certificate that provides authority for a declarative/persistent work order from client node 204 to be executed in endpoint 408. In an example, server 202 may provide the request to authenticator device 206 via any suitable manner or communication path. For example, server 202 may provide the request to authenticator device 206 via a communication path through client node 204. In an example, the communication path for the request certificate may go through client node 204 for any suitable reason including, but not limited to, authenticator 206 being a key fob connected to client node 204.

At operation 616, authenticator node/device 206 may sign the request with a private key associated with the user of client node 204. At operation 618, authenticator 206 may provide the signed request certificate to server 202. In an example, authenticator 206 may provide the signed request to server 202 via the same communication path that the server sent the request to the authenticator. In certain examples, authenticator 206 may sign and return the request certificate via any suitable protocol such as WebAuthn or the like.

At operation 620, server 202 may provide the signed request certificate to one or more endpoints 408. In an example, the signed request certificate may be signed with a private key of the user of client node 204. However, endpoint node 408 may not have the public key for the user of client node 204. In this example, endpoint node 408 may have the public key for the administrator stored within a storage. At operation 622, server node 202 may provide the authorization certificate and signature previous stored in the server node as described above with respect to FIG. 5. At operation 624, based on the signed request certificate from authenticator 206, public key of the administrator, and the authorization certificate and signature granting permission to user of client node 204, endpoint node 408 may verify the work order and perform the associated operations received from client node 204.

As described above, all the operations performed by authenticator nodes 102 and 206 and administrator node 506 may be completed utilizing WebAuthn. In an example, the operations may be any suitable operations including, but not limited to, key enrollment, signature generation, and signature validation. In certain examples, authenticators 106 and 106 may utilize WebAuthn to sign and approve long-lived control-plane operations, to sign and approve long-lived security attestations, or the like. Processors in server/control plane nodes 108, 202, and 502 and endpoint nodes 104 and 408 may execute operations as validating agents to use long-lived WebAuthn-signed documents to assess permissions for users accessing the endpoints.

In certain examples, server/control plane nodes may utilize WebAuthn-signed data for persistent, durable assessors of longer-lived or non-ephemeral operations. In an example, server/control plane node may relay of longer-lived or non-random signed WebAuthn messages to entities or devices other than those directly involved in a handling of a declarative or long-lasting work order request for separate verification. In certain examples, server/control plane nodes may embed multiple signatures and signature formats in a proof or certificate to allow devices which defined their own signature formats to be used for different purposes. In an example, server/control plane nodes may provide FIDO2 WebAuthn signed challenges to other devices for further independent attestation of signatures. In certain examples, a multiple node system may utilize indirect registration of user public keys. For example, one entity could enroll an authenticator, and make the associated public key available to other entities, such as a server/control plane node, endpoint nodes, or the like.

FIG. 7 shows a generalized embodiment of an information handling system 700 according to an embodiment of the present disclosure. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 700 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 700 can include processing resources for executing machine-executable code, such as a central processing unit (CPU), a programmable logic array (PLA), an embedded device such as a System-on-a-Chip (SoC), or other control logic hardware. Information handling system 700 can also include one or more computer-readable medium for storing machine-executable code, such as software or data. Additional components of information handling system 700 can include one or more storage devices that can store machine-executable code, one or more communications ports for communicating with external devices, and various input and output (I/O) devices, such as a keyboard, a mouse, and a video display. Information handling system 700 can also include one or more buses operable to transmit information between the various hardware components.

Information handling system 700 can include devices or modules that embody one or more of the devices or modules described below and operates to perform one or more of the methods described below. Information handling system 700 includes a processors 702 and 704, an input/output (I/O) interface 710, memories 720 and 725, a graphics interface 730, a basic input and output system/universal extensible firmware interface (BIOS/UEFI) module 740, a disk controller 750, a hard disk drive (HDD) 754, an optical disk drive (ODD) 756, a disk emulator 760 connected to an external solid state drive (SSD) 762, an I/O bridge 770, one or more add-on resources 774, a trusted platform module (TPM) 776, a network interface 780, a management device 790, and a power supply 795. Processors 702 and 704, I/O interface 710, memory 720, graphics interface 730, BIOS/UEFI module 740, disk controller 750, HDD 754, ODD 756, disk emulator 760, SSD 762, I/O bridge 770, add-on resources 774, TPM 776, and network interface 780 operate together to provide a host environment of information handling system 700 that operates to provide the data processing functionality of the information handling system. The host environment operates to execute machine-executable code, including platform BIOS/UEFI code, device firmware, operating system code, applications, programs, and the like, to perform the data processing tasks associated with information handling system 700.

In the host environment, processor 702 is connected to I/O interface 710 via processor interface 706, and processor 704 is connected to the I/O interface via processor interface 708. Memory 720 is connected to processor 702 via a memory interface 722. Memory 725 is connected to processor 704 via a memory interface 727. Graphics interface 730 is connected to I/O interface 710 via a graphics interface 732 and provides a video display output 736 to a video display 734. In a particular embodiment, information handling system 700 includes separate memories that are dedicated to each of processors 702 and 704 via separate memory interfaces. An example of memories 720 and 730 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 740, disk controller 750, and I/O bridge 770 are connected to I/O interface 710 via an I/O channel 712. An example of I/O channel 712 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 710 can also include one or more other I/O interfaces, including an Industry Standard Architecture (ISA) interface, a Small Computer Serial Interface (SCSI) interface, an Inter-Integrated Circuit (I2C) interface, a System Packet Interface (SPI), a Universal Serial Bus (USB), another interface, or a combination thereof. BIOS/UEFI module 740 includes BIOS/UEFI code operable to detect resources within information handling system 700, to provide drivers for the resources, initialize the resources, and access the resources. BIOS/UEFI module 740 includes code that operates to detect resources within information handling system 700, to provide drivers for the resources, to initialize the resources, and to access the resources.

Disk controller 750 includes a disk interface 752 that connects the disk controller to HDD 754, to ODD 756, and to disk emulator 760. An example of disk interface 752 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 760 permits SSD 764 to be connected to information handling system 700 via an external interface 762. An example of external interface 762 includes a USB interface, an IEEE 7394 (Firewire) interface, a proprietary interface, or a combination thereof. Alternatively, solid-state drive 764 can be disposed within information handling system 700.

I/O bridge 770 includes a peripheral interface 772 that connects the I/O bridge to add-on resource 774, to TPM 776, and to network interface 780. Peripheral interface 772 can be the same type of interface as I/O channel 712 or can be a different type of interface. As such, I/O bridge 770 extends the capacity of I/O channel 712 when peripheral interface 772 and the I/O channel are of the same type, and the I/O bridge translates information from a format suitable to the I/O channel to a format suitable to the peripheral channel 772 when they are of a different type. Add-on resource 774 can include a data storage system, an additional graphics interface, a network interface card (NIC), a sound/video processing card, another add-on resource, or a combination thereof. Add-on resource 774 can be on a main circuit board, on separate circuit board or add-in card disposed within information handling system 700, a device that is external to the information handling system, or a combination thereof.

Network interface 780 represents a NIC disposed within information handling system 700, on a main circuit board of the information handling system, integrated onto another component such as I/O interface 710, in another suitable location, or a combination thereof. Network interface device 780 includes network channels 782 and 784 that provide interfaces to devices that are external to information handling system 700. In a particular embodiment, network channels 782 and 784 are of a different type than peripheral channel 772 and network interface 780 translates information from a format suitable to the peripheral channel to a format suitable to external devices. An example of network channels 782 and 784 includes InfiniBand channels, Fibre Channel channels, Gigabit Ethernet channels, proprietary channel architectures, or a combination thereof. Network channels 782 and 784 can be connected to external network resources (not illustrated). The network resource can include another information handling system, a data storage system, another network, a grid management system, another suitable resource, or a combination thereof.

Management device 790 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 700. In particular, management device 790 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 700, such as system cooling fans and power supplies. Management device 790 can include a network connection to an external management system, and the management device can communicate with the management system to report status information for information handling system 700, to receive BIOS/UEFI or system firmware updates, or to perform other task for managing and controlling the operation of information handling system 700.

Management device 790 can operate off of a separate power plane from the components of the host environment so that the management device receives power to manage information handling system 700 when the information handling system is otherwise shut down. An example of management device 790 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 790 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A control plane node of a multiple node environment, the control plane node comprising:
a storage configured to store a signed authorization certificate, wherein the signed authorization certificate grants permission to a user to perform an operation within an endpoint of the multiple node environment; and
a processor to communicate with the storage, the processor to:
receive, from a client node, a request including a work order for the operation to be performed in the endpoint node; and
in response to reception of the request, the processor to:
provide a request certificate to an authenticator device associated with an administrator of the endpoint node;
receive a signed request certificate; and
provide the signed request certificate to the endpoint node for verification.

2. The control plane node of claim 1, wherein the processor further to: provide the signed authorization certificate with the signed request certificate to the endpoint node for verification.

3. The control plane node of claim 1, wherein the processor further to:
provide an authorization certificate to an administrator node of the multiple node environment;
receive the signed authorization certificate from the administrator node; and
store the signed authorization certificate in the storage.

4. The control plane node of claim 1, wherein the signed authorization certificate is signed with a private key of the administrator.

5. The control plane node of claim 1, wherein signed request certificate is signed with a private key of an owner of the endpoint node.

6. The control plane node of claim 5, wherein the private key of the owner is part of a private/public key combination with an owner public key stored in the endpoint node.

7. The control plane node of claim 1, wherein the authorization certificate is a long-lived attestation of permission for the user to perform the operation in the endpoint node.

8. The control plane node of claim 1, wherein the work order is a long-lived request for the operation to be performed in the endpoint node.

9. A method comprising:
receiving, by a processor of a control plane node in a multiple node environment, a request including a work order for the operation to be performed in the endpoint node, wherein the work order is received from a client node; and
in response to reception of the request:
providing a request certificate to an authenticator device associated with an administrator of the endpoint node;
receiving a signed request certificate; and
providing the signed request certificate to the endpoint node for verification.

10. The method of claim 9, further comprising: providing the signed authorization certificate with the signed request certificate to the endpoint node for verification.

11. The method of claim 9, further comprising:
providing an authorization certificate to an administrator node of the multiple node environment;
receiving the signed authorization certificate from the administrator node; and
storing the signed authorization certificate in the storage.

12. The method of claim 9, wherein the signed authorization certificate is signed with a private key of the administrator.

13. The method of claim 9, wherein signed request certificate is signed with a private key of an owner of the endpoint node.

14. The method of claim 13, wherein the private key of the owner is part of a private/public key combination with an owner public key stored in the endpoint node.

15. The method of claim 9, wherein the authorization certificate is a long-lived attestation of permission for the user to perform the operation in the endpoint node.

16. The method of claim 9, wherein the work order is a long-lived request for the operation to be performed in the endpoint node.

17. A method comprising:
providing, by a control plane node of a multiple node environment, an authorization certificate to an administrator node of the multiple node environment;
receiving the signed authorization certificate from the administrator node;
storing the signed authorization certificate in the storage;
receiving, by a processor of the control plane node in a multiple node environment, a request including a work order for the operation to be performed in the endpoint node, wherein the work order is received from a client node; and
in response to reception of the request:
providing a request certificate to an authenticator device associated with an administrator of the endpoint node;
receiving a signed request certificate;
providing the signed request certificate to the endpoint node for verification; and
providing the signed authorization certificate with the signed request certificate to the endpoint node for verification.

18. The method of claim 17, wherein the signed authorization certificate is signed with a private key of the administrator.

19. The method of claim 17, wherein the authorization certificate is a long-lived attestation of permission for the user to perform the operation in the endpoint node.

20. The method of claim 17, wherein the work order is a long-lived request for the operation to be performed in the endpoint node.
